(19) United States
(12) Patent Application Publication
(10) Pub. No.: US 2009/0218328 A1
(43) Pub. Date: Sep. 3, 2009

(54) NOZZLE

(76) Inventors: Andrew Neil Johnson, Surrey (GB); Christopher Peter Rand, Surrey (GB)

Correspondence Address: The BOC Group, Inc., 575 MOUNTAIN AVENUE, MURRAY HILL, NJ, 07974-2082, US

(21) Appl. No.: 12/091,349

(22) PCT Filed: Oct. 23, 2006
(86) PCT No.: PCT/GB2006/050346

§ 371 Date: Aug. 4, 2008

(30) Foreign Application Priority Data
Nov. 1, 2005 (GB) 0522317.7

(51) Int. Cl. B23K 37/00; B05B 1/32; F25D 3/12

(52) U.S. Cl. 219/136; 239/584; 62/168

(57) ABSTRACT

The invention relates to a nozzle (16) for emitting solid carbon dioxide particles. The nozzle (16) comprising an inlet (30) for receiving liquid carbon dioxide, a nozzle aperture (32) from which solid carbon dioxide particles flow from the nozzle (16), a duct extending between the inlet (30) and the nozzle aperture (32), the duct having a convergent section (36) and a divergent section (38), and an axially displaceable valve member (42) located within the duct, the valve member (42) having first and second convergent portions and a substantially cylindrical portion located between the first and second convergent portions. The nozzle (16) finds particular use in apparatus for cooling a heated weld zone in a workpiece.

The present invention relates to a nozzle for emitting solid carbon dioxide particles, and to apparatus comprising such a nozzle for cooling a heated weld zone produced in a workpiece by a welding process.

During the thermal welding of metallic workpieces a high heat input is required to generate an acceptable weld. However, this high heat input has the disadvantage that the thermal stresses generated by the welding process can cause significant levels of distortion of the workpieces being welded. Sheet workpieces of relatively soft metals and alloys such as mild steel, titanium, titanium alloys and stainless steels are particularly prone to distortion and reduced tensile strength.

It is known to use gases to provide forced cooling during arc welding processes. However, the results of using cooling gases are limited as the cooling ability of the gas streams is relatively low. Cryogens, particularly liquid nitrogen and solid carbon dioxide, have been used to provide enhanced cooling to arc welding processes, but if the weld zone is cooled excessively this can lead to distortion of the workpieces in the opposite direction. It is therefore desirable to balance the amount of cooling of the weld zone with the heat input from the welding process to result in little or no distortion of the workpieces.

In a first aspect, the invention provides apparatus for cooling a heated weld zone formed in a workpiece by a welding process, the apparatus comprising a nozzle for emitting solid carbon dioxide particles towards the weld zone, the nozzle comprising an inlet for receiving liquid carbon dioxide, a nozzle aperture from which solid carbon dioxide particles flow from the nozzle, a duct extending between the inlet and the nozzle aperture, the duct having a convergent section and a divergent section, and an axially displaceable valve member located within the duct, the valve member having first and second convergent portions and a substantially cylindrical portion located between the first and second convergent portions.

A high velocity gas stream containing solid carbon dioxide particles can be produced by the adiabatic expansion of liquid carbon dioxide as it passes through a nozzle. Solid CO₂ particles collide with the hot surface of the weld zone and are rapidly sublimated as heat is extracted from the weld zone.

The apparatus preferably comprises a control system for controlling the position of the valve member within the duct. The rate at which the weld zone is cooled is dependent upon the rate at which solid CO₂ particles impact the surface of the weld zone. By controlling the position of the valve member within the duct, the rate at which solid CO₂ particles flow from the nozzle, and therefore the cooling rate of the weld zone, can be controlled so that distortion of the workpiece can be inhibited.

The flow rate of solid CO₂ particles from the nozzle, and therefore the position of the valve member within the duct, may be controlled in dependence on one or more of the following parameters:
the temperature of the weld zone;
one or more operational parameter of the welding process, such as welding voltage, welding current, the speed of the welding tool used to form the weld zone and the time taken to form the weld zone;
the thickness of the workpiece;
the material from which the workpiece is formed;
the nature of the welding process (for example, MIG, TIG or submerged arc welding); and
any strain measurement technique used to measure the residual stresses within the workpiece.

Information relating to the thickness and material of the workpiece, and the welding process, may be input into a control interface by an operator. Information relating to the various operational parameters of the welding process may be similarly input by the operator, or supplied to the control system directly by the welding tool. A non-contact temperature detector, such as an infrared temperature sensor, may be positioned in close proximity to the weld zone so that information relating to the temperature of the weld zone can be supplied to the control system. Similarly, strain gauges may also be positioned in close proximity to the weld zone so that information relating to deformation of the workpiece during the welding process can be supplied to the control system. This can enable the control system to rapidly and automatically adjust the ejection rate of the solid CO₂ particles in response to variation in the temperature of the weld zone and/or the operational parameters of the welding process and/or deformation of the workpiece so as to minimise residual stresses generated in the workpiece. Use of such a control system can also enable detailed cooling procedures to be created and performed in a controlled and reproducible manner.

The nozzle is preferably spaced from the workpiece by a distance in the range from 30 to 50 mm. Liquid carbon dioxide is preferably supplied to the nozzle at a pressure in the range from 16 to 18 bar.

The nozzle comprises a duct through which liquid carbon dioxide is expanded, a nozzle aperture through solid CO₂ particles are emitted from the nozzle, and a valve member moveable within the duct to vary the flow rate of solid CO₂ particles from the nozzle. The valve member is preferably in the form of an elongate valve member that is axially displaceable within the duct to control the cross-section of the flow of CO₂ through the duct, and thereby control the flow rate of solid CO₂ particles from the nozzle.

The duct comprises a convergent section in which liquid carbon dioxide is accelerated towards a sonic speed. The second convergent portion of the valve member is preferably located at least partially within the convergent section such that axial displacement of the valve member relative to the convergent section varies the cross-section of the flow of CO₂ through the duct. The second convergent portion preferably has a taper angle that is substantially the same as that of the convergent section of the duct, so that in a closed position of the valve member the second convergent portion of the valve member engages the convergent section of the duct to prevent flow of CO₂ from the nozzle.

The duct and valve member are profiled to control the location of the minimum cross-section of the CO₂ flow when the valve member is subsequently moved to an open position. For example, in the preferred embodiment the duct has a throat located between the convergent section and the nozzle aperture. The valve member has a substantially cylindrical portion located between the convergent portions of the valve member, and having a diameter slightly smaller than, preferably between 5 and 15 μm smaller than, the diameter of the throat so that, in the closed position, the cylindrical portion is located just beneath or adjacent the throat. As the valve member is axially displaced from the closed position to an open position, the cylindrical portion of the valve member can be rapidly positioned within the throat, in the preferred embodiment within an axial displacement of between 0 and 100 μm, for example around 50 μm, from the closed position. This can rapidly establish the minimum cross-section of the CO₂ flow through the duct at the throat, inhibiting solid CO₂ formation upstream from the throat.

The cylindrical portion of the valve member preferably extends between 0.4 and 0.6 mm between these convergent portions of the valve member. The first convergent portion, located between the cylindrical portion and tip of the valve member, preferably has a taper angle that is smaller than that of the first convergent portion. The taper angle of the first convergent section of the valve member is between 5 and 15°, and the taper angle of the second convergent section of the valve member is between 15 and 25°.

The duct comprises a divergent section located between the convergent section and the nozzle aperture so that as the liquid carbon dioxide passes through the throat it expands, resulting in a phase change from liquid carbon dioxide to solid and gaseous carbon dioxide. As the gaseous carbon dioxide flows through the divergent section of the duct, it further expands and therefore increases in speed. Consequently, the solid carbon dioxide particles entrained within the gaseous carbon dioxide are accelerated towards the weld zone to impact with the weld zone at a high velocity. This can enable the solid CO₂ particles to impact the surface of the weld zone with sufficient velocity to allow a good heat transfer rate to occur without a gas insulant layer being created.

Movement of the valve member within the duct may be actuated by any suitable electro-mechanical device, such as a linear or stepper motor. An encoder or other linear position sensor may be provided for tracking motion of the valve member, and for providing data to a controller of the control system for use in controlling the motor drive.

In a second aspect, the present invention provides welding apparatus comprising a welding tool for forming a weld zone in a workpiece and cooling apparatus as aforementioned for cooling the weld zone. The cooling apparatus may be arranged relative to the welding tool such that the nozzle is spaced from the welding tool by a fixed distance, for example in the range from 50 to 100 mm, during relative movement between the welding tool and the workpiece. The cooling apparatus and the welding tool may be stationary, with the workpiece moved relative to the tool and cooling apparatus to form a weld line in the workpiece. Alternatively, the workpiece may be stationary, with the welding tool and cooling apparatus moved relative to the workpiece.

The nozzle may be used for purposes other than cooling a heated weld zone, and so in a third aspect the present invention provides a nozzle for emitting solid carbon dioxide particles, the nozzle comprising an inlet for receiving liquid carbon dioxide, a nozzle aperture from which solid carbon dioxide particles flow from the nozzle, a duct extending between the inlet and the nozzle aperture, the duct having a convergent section and a divergent section, and an axially displaceable valve member located within the duct, the valve member having first and second convergent portions and a substantially cylindrical portion located between the first and second convergent portions.

Features described above in relation to the first aspect of the invention are equally applicable to the second and third aspects of the invention, and vice versa.

Preferred features of the present invention will now be described with reference to the accompanying drawings, in which:

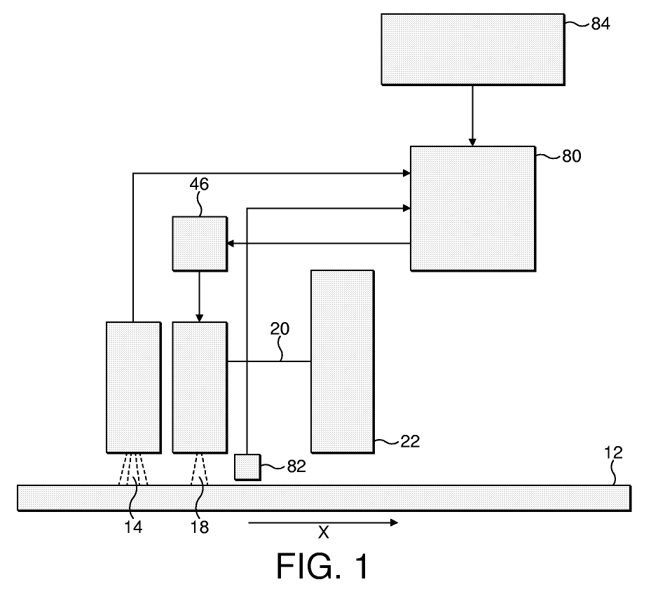

FIG. 1 illustrates apparatus for welding a workpiece;

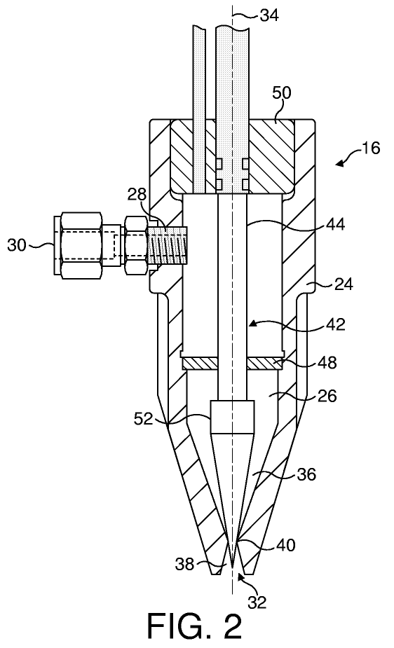

FIG. 2 is a cross-sectional view of a nozzle from which solid carbon dioxide particles flow toward the weld zone formed in the workpiece;

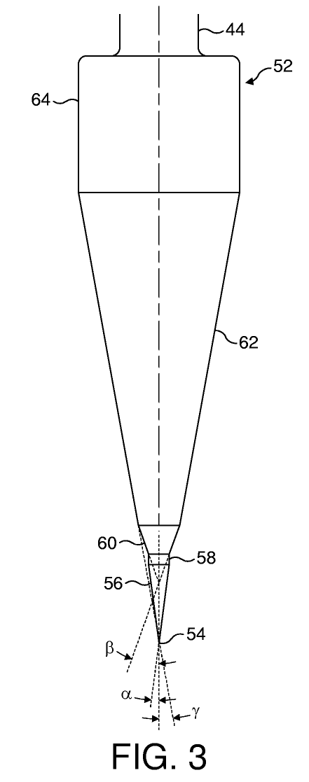

FIG. 3 illustrates the tapered head of a valve member of the nozzle of FIG. 2;

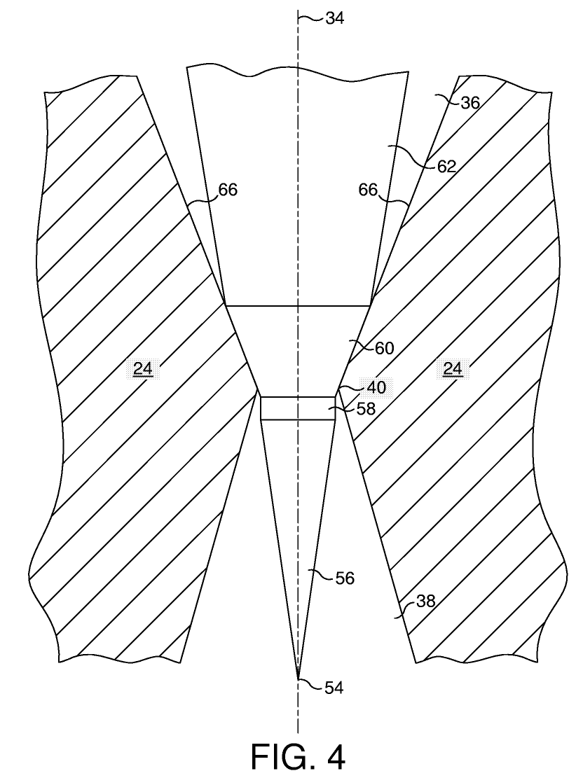

FIG. 4 illustrates the tapered head of the valve member when the valve member is in a closed position; and

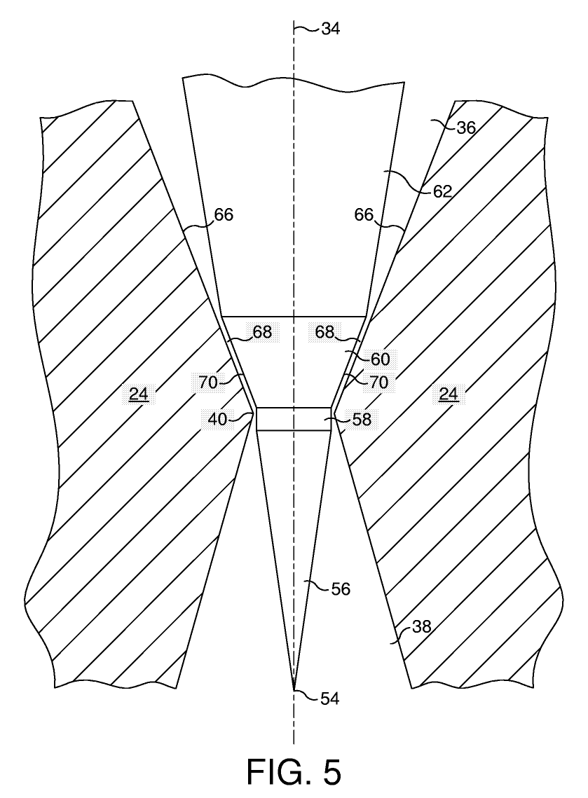

FIG. 5 illustrates the tapered head of the valve member when the valve member is in an open position.

FIG. 1 illustrates a welding tool 10 for welding a workpiece 12, in this example in the form of a sheet metal plate. The welding tool 10 may be any form of welding torch, such as a MIG welding torch. As is known, such a welding torch feeds a consumable electrode to a weld zone of the workpiece 12. An electric arc 14 is struck between the tip of the electrode and the workpiece 12 in the vicinity of the weld zone. Molten metal is transferred from the electrode to the weld zone through the arc 14. A shielding gas, typically consisting of argon, optionally with relatively small quantities of oxygen and carbon dioxide added, is supplied from the welding torch around the consumable electrode so as to inhibit oxidation of the weld metal. The workpiece 12 may be moved relative to the welding tool 10 to cause the weld zone to move along the workpiece, or the welding tool 10 may be moved relative to the workpiece 12.

In order to cool the weld zone formed in the workpiece 12, a nozzle 16 is provided for emitting a supersonic stream 18 of solid CO₂ particles towards the heated weld zone. The nozzle 16 is spaced from the welding tool 10, preferably by a distance in the range from 50 to 100 mm in the direction (indicated at X in FIG. 1) of relative movement between the welding tool 10 and the workpiece 12, so that the weld zone formed in the workpiece 12 by the welding tool 10 is impacted by the stream 18 of solid CO₂ particles flowing from the nozzle 16 without the CO₂ stream impinging upon the shielding gas surrounding the melt pool formed in the workpiece 12 during the welding process.

The nozzle 16 receives liquid CO₂ from a supply line 20 connected between the nozzle 16 and a supply tank 22 storing liquid CO₂ at a pressure in the range from 16 to 18 bar. A valve (not shown) may be provided in the supply line 20 for closing the supply of CO₂ to the nozzle. A phase separator (not shown) is also provided in the supply line 20 for separating gaseous CO₂ from liquid CO₂. As described in more detail below, the stream 18 of solid CO₂ particles is formed through adiabatic expansion of the liquid CO₂ within the nozzle 16. This causes the pressure of the liquid CO₂ to fall below the triple point pressure of CO₂, resulting in a phase change from liquid CO₂ to a mixture of solid CO₂ particles and gaseous CO₂.

FIG. 2 illustrates the nozzle 16 in more detail. The nozzle 16 has an elongate tubular body 24 housing a CO₂ flow duct 26. A CO₂ inlet 28 supplies liquid CO₂ radially into the duct 26, a connector 30 being provided for connecting the inlet 28 to the supply line 20. A nozzle aperture 32 co-axial with the longitudinal axis 34 of the duct 26 emits a jet stream of gaseous CO₂ and solid CO₂ particles from the duct 26. The duct 26 has a convergent section 36, and a divergent section 38 located between the convergent section 36 and the nozzle aperture 32, the intersection of the convergent and divergent sections 36, 38 of the duct 26 defining a throat 40 at which the cross-section of the duct 26 is at a minimum. The nozzle aperture 32 is preferably spaced from the workpiece 12 by a distance in the range from 25 to 125 mm, most preferably in the range from 30 to 50 mm.

The nozzle 16 includes a valve member 42 that is moveable within the duct 26 to vary the flow rate of solid carbon dioxide particles from the nozzle. In this example, the valve member 42 is in the form of an elongate valve member 42 that is axially displaceable along the longitudinal axis 34 of the duct 26 and aligned co-axially therewith. The valve member 42 has a shaft 44 that projects outwardly from the body 24 of the nozzle 16 and is coupled to an electro-mechanical device 46, such as a linear or stepper motor, for axially displacing the valve member 42 within the duct 26 to vary the flow of CO₂ through the duct 26. The shaft 44 is supported within the duct 26 by a support spider 48, and also by a guide bushing 50 that closes the end of the duct 26 opposite the nozzle aperture 32.

The valve member 42 also has a tapered head 52, the profile of which is illustrated in FIG. 3. From the tip 54 of the valve member 42, the head 52 comprises a first convergent section 56 having a taper angle α, in this example between 5 and 10°, a first substantially cylindrical portion 58, a second convergent section 60 having a taper angle β, where β>α, in this example between 15 and 25°, a third convergent section 62 having a taper angle γ, where γ≈α, and a second substantially cylindrical portion 64. The first cylindrical portion 58 has a length in the range from 0.4 to 0.6 mm, in this example 0.5 mm, and a diameter that is in the range from 1.5 to 1.7 mm, in this example approximately 1.59 mm, and is slightly less than the diameter of the throat 40 of the duct 26, which in this example is approximately 1.60 mm.

FIG. 4 illustrates the position of the head 52 relative to the throat 40 of the duct when the valve member 42 is in a closed position. In this position, the outer surface of the second convergent portion 60 of the head 52 engages the inner surface 66 of the convergent section 36 of the duct 26 to form a seal that prevents flow of CO₂ into the divergent section 38 of the duct 26. In the closed position, the first cylindrical portion 58 of the head 52 is located just beneath (as illustrated) the throat 40 of the duct 26, and is preferably no more than 100 μm beneath the throat 40. In this example, the cylindrical portion 58 is less than 50 μm beneath the throat 40 when the valve member 42 is in the closed position.

As the valve member 42 is axially displaced from the closed position to an open position by actuation of the electro-mechanical device 46, an annular flow channel 68 is created between the inner surface of the duct 26 and the outer surface of the head 52, as illustrated in FIG. 5. The duct 26 and valve member 42 are profiled so that when the valve member 42 is in an open position, the cross-section of the annular flow channel 68 narrows between the inlet 28 and the throat 40 so that the speed of liquid CO₂ increases towards a supersonic speed, and then widens from the throat 40 to the nozzle aperture 32 so that the liquid CO₂ expands whilst gathering further speed to reach a supersonic speed. As mentioned above, expansion of the liquid CO₂ causes the pressure of the liquid CO₂ to fall below the triple point pressure of CO₂, resulting in a phase change from liquid CO₂ to a mixture of solid CO₂ particles and gaseous CO₂.

In order to inhibit formation of solid CO₂ particles upstream from the throat 40 of the duct 26, the first cylindrical portion 58 of the head 52 is preferably located less than 50 μm beneath the throat 40 when the valve member 42 is in the closed position, and has a diameter that is preferably around 0.1 mm less than that of the duct 26. Consequently, within the first 50 μm axial displacement of the valve member 42, the first cylindrical portion 58 is located within the throat 40, where it remains, in this embodiment, for the next 0.5 mm axial displacement of the valve member, this being the length of the first cylindrical portion 58. Due to the narrow annular gap established between the first cylindrical portion 58 and the throat 40 of the duct 26 during this period, as the wall 70 of the second convergent portion 60 of the head 52 continues to move away from the wall 66 of the convergent section 36 of the duct 26 the minimum cross-section of the annular flow channel at the throat 40 of the duct 26 is rapidly established at the throat 40.

With continued axial displacement of the valve member 42 from the closed position, the first convergent portion 56 of the head 52 becomes located within the throat 40 of the duct 26. Due to the narrow taper of this portion 56 of the head 52, in this example α≈8°, the minimum cross-section of the annular flow channel 68 remains located at the throat 40, and the size of the minimum cross-section increases gradually with continued axial displacement of the valve member 42. Furthermore, the shape of the first convergent portion 56 of the head 52 enables a concentrated, controlled stream of solid carbon dioxide particles to flow from the nozzle towards the weld zone, thereby optimising the efficiency of the cooling of the weld zone.

As the valve member 42 is axially displaced from the closed position, the size of the annular flow channel 68 within the convergent section 38 of the duct 26 increases, and so both the flow rate of CO₂ through the duct 26 and the amount of solid CO₂ particles flowing from the nozzle 16 increases with movement of the valve member 42 from the closed position. Consequently, the flow rate of solid CO₂ particles towards the heated weld zone, and therefore the rate of cooling of the weld zone, can be controlled through control of the position of the valve member 42 within the duct 26. Returning to FIG. 1, a control system is provided for controlling the position of the valve member 42. The control system includes the electro-mechanical drive 46 for actuating the axial displacement of the valve member 42, and a controller 80 for controlling actuation of the drive 46 and thereby control the position of the valve member 42 relative to the duct 26. The controller 80 may be configured to control the drive 46 in dependence on one or more parameters, including, but not limited to:
the temperature of the weld zone;
one or more operational parameter of the welding process, such as welding voltage, welding current, the speed of the welding tool 10 and the time taken to form the weld zone;
the thickness of the workpiece 12;
the material from which the workpiece 12 is formed;
the nature of the welding process (for example, MIG, TIG or submerged arc welding); and
any strain measurement technique used to measure the residual stresses within the workpiece 12.

Information relating to the temperature of the weld zone may be provided by an infrared temperature sensor 82 located adjacent the nozzle 16. The infrared temperature sensor 82 absorbs ambient infrared radiation given off by the heated weld zone. The incoming light is converted to an electric signal, which corresponds to a particular temperature, and is supplied to the controller 80. The controller 80 can then rapidly and automatically adjust the flow rate of the solid CO₂ particles from the nozzle 16 in response to variation in the temperature of the weld zone.

In addition to, or as an alternative to, using a temperature sensor 82 to provide information regarding the temperature of the weld zone, a strain measurement technique may be used to provide information regarding deformation of the workpiece during the welding process, with the controller 80 rapidly and automatically adjusting the flow rate of the solid CO₂ particles from the nozzle 16 in response to the deformation of the workpiece 12.

Information relating to the thickness and material of the workpiece may be input into a control interface 84 by an operator and supplied to the controller 80 for controlling the flow rate of the solid CO₂ particles from the nozzle 16. The interface may be physically separate from the controller 80, or it may be integral with the controller 80. Information relating to the various operational parameters of the welding process, and relating to the nature of the welding process itself, may be similarly input by the operator using the control interface 84, or supplied to the controller directly by the welding tool.

The control system may also include an encoder (not shown) for monitoring the position of the valve member 42, and for supplying signals indicative of the current position of the valve member 42 to the controller 80 for use in controlling the drive 46.

The current rate at which CO₂ is flowing from the nozzle can be used to modulate the extraction rate of gases from the weld zone in order to capture the spent coolant whilst both preventing the arc from being blown out, and preventing extraction of the shielding gases surrounding the melt pool during the welding process.

1. A nozzle for emitting solid carbon dioxide particles, the nozzle comprising an inlet for receiving liquid carbon dioxide, a nozzle aperture from which solid carbon dioxide particles flow from the nozzle, a duct extending between the inlet and the nozzle aperture, the duct having a convergent section and a divergent section, and an axially displaceable valve member located within the duct, the valve member having first and second convergent portions and a substantially cylindrical portion located between the first and second convergent portions.

2. The nozzle according to claim 1, wherein the valve member comprises an elongate valve member that is axially displaceable within the duct to control the cross-section of the flow of carbon dioxide through the duct.

3. The nozzle according to claim 1, wherein the second convergent portion of the valve member contacts the convergent section of the duct when the valve member is in a closed position.

4. The nozzle according to claim 1, wherein the second convergent portion of the valve member has a taper angle that is substantially the same as that of the convergent section of the duct.

5. The nozzle according to claim 1, wherein the taper angle of the second convergent portion is between 15 and 25°.

6. The nozzle according to claim 1, wherein the duct comprises a throat located between the convergent section and the divergent section, and wherein the cylindrical portion is located between the throat and the nozzle aperture when the valve member is in a closed position.

7. The nozzle according to claim 6, wherein the cylindrical portion is spaced from the throat by a distance between 0 and 100 μm when the valve member is in a closed position.

8. The nozzle according to claim 6, wherein the diameter of the cylindrical portion is between 5 and 15 μm smaller than the diameter of the throat.

9. The nozzle according to claim 1, wherein the cylindrical portion extends between the convergent portions of the valve member by a distance in the range from 0.4 to 0.6 mm.

10. The nozzle according to claim 1, wherein the taper angle of the first convergent portion is smaller that the taper angle of the second convergent portion.

11. The nozzle according to claim 1, wherein the taper angle of the first convergent section of the valve member is between 5 and 15°.

12. Apparatus for cooling a heated weld zone formed in a workpiece by a welding process, the apparatus comprising a nozzle according to claim 1 for emitting solid carbon dioxide particles towards the weld zone.

13. The apparatus according to claim 12, comprising a control system for controlling the position of the valve member within the duct.

14. The apparatus according to claim 13, wherein the control system is configured to control the position of the valve member within the duct in dependence on the temperature of the weld zone.

15. The apparatus according to claim 14, wherein the control system is configured to receive signals indicative of the temperature of the weld zone from a thermal sensor located proximate the weld zone.

16. The apparatus according to claim 13, wherein the control system is configured to control the position of the valve member within the duct in dependence on at least one operational parameter of the welding process.

17. The apparatus according to claim 16, wherein said at least one operational parameter of the welding process comprises at least one of welding current, welding voltage, the speed of a welding tool used to form the weld zone and the time taken to form the weld zone.

18. The apparatus according to claim 13, wherein the control system is configured to control the flow rate of solid carbon dioxide particles from the nozzle in dependence on the deformation of the workpiece during the welding process.

19. The apparatus comprising a welding tool for forming a weld zone in a workpiece, and cooling apparatus according to claim 13 for cooling the weld zone.

20. The apparatus according to claim 19, wherein the cooling apparatus is arranged relative to the welding tool such that the nozzle is spaced from the welding tool by a distance in the range from 50 to 100 mm.
